(19) United States
(12) Patent Application Publication
(10) Pub. No.: US 2007/0222939 A1
(43) Pub. Date: Sep. 27, 2007

(54) Personalized glasses

(76) Inventor: Donald E. Hodgson, Erie, CO (US)

Correspondence Address: Don Hodgson, Unit 5, 400 Young Ct., Erie, CO, 80516, US

(21) Appl. No.: 11/388,098

(22) Filed: Mar. 23, 2006

(51) Int. Cl. G02C 5/00

(52) U.S. Cl. 351/41

(57) ABSTRACT

A pair of glasses having a frame lens or lenses on either side of the nose piece. On each side of the lens or lenses is an earpiece. The earpiece can be put on a hinge or one piece with lens or frame.

### FIELD OF THE INVENTION

The invention is directed to sun glasses or eye glasses to use for better vision or eye protection from small objects, weather and the sun.

### BRIEF DESCRIPTION OF THE DRAWINGS

FIG. 1 Front view of the invention.

FIG. 2 Side view with extra material on the earpiece.

FIG. 3 Side with the invention with hinged earpiece without the extra material.

FIG. 4. Front view of the invention with frames.

### DETAILED DESCRIPTION OF INVENTION

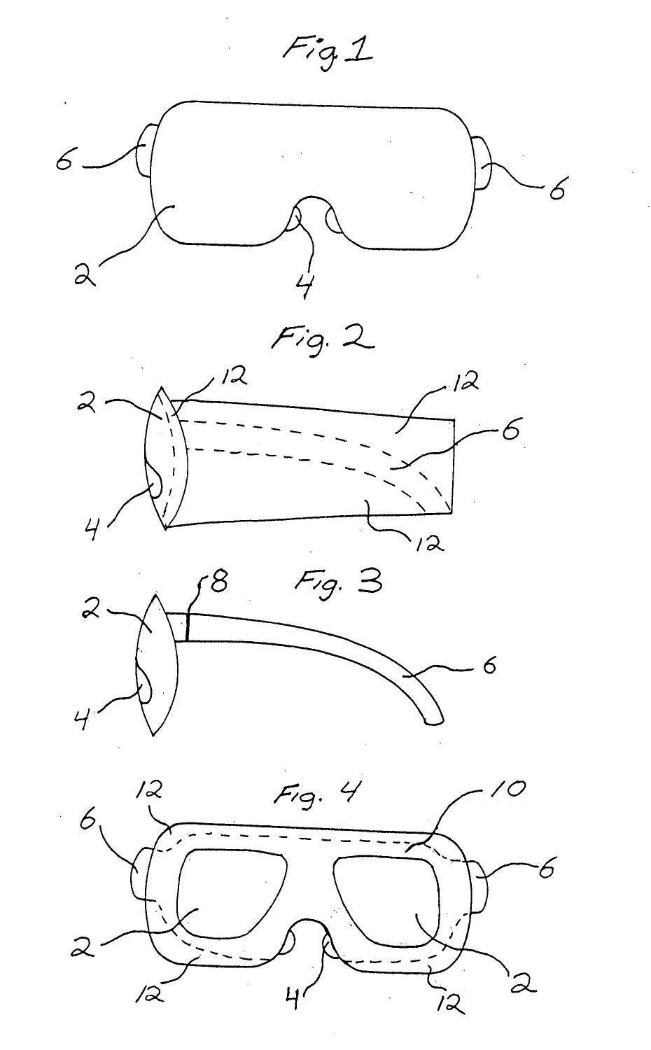

In FIG. 1 there is illustrated a pair of glasses having a lens (2) in the middle of each lens (2) a nose piece (4) on either end of lens (2) there are earpieces (6)

In FIG. 2 there is illustrated a pair of glasses where the lens (2) and earpiece (6) are one piece and both earpieces (6) and lens(2) having extra material (12).

In FIGS. 3 and 4 there is illustrated a pair of glasses Having frame (10) attached to the frame (10) is A hinge (8) attached to the other side of hinge (8) is an earpiece (6) without extra material. In the middle of frame (10) there is a nose piece (4).

What is claimed:

1. A pair of eyeglasses

2. A pair of eyeglasses of claim 1, wherein extra material is provided to the lens or lenses to be removed later by means of a cutting tool such as a scissor to the desired shape the customer wants.

3. A pair of eyeglasses of claim 1, wherein extra material is provided to earpieces to be removed by a cutting tool scissors to the desired length and shape the customer wants.

4. A pair of eyeglasses of claim 1, wherein extra material is provided to frame to be removed later by means of a cutting tool such as scissors to desired shape the customer wants.

5. A pair of eyeglasses of claim 1, wherein extra material provided can be removed by the supplier or the customer.
